(19) United States
(12) Patent Application Publication
(10) Pub. No.: US 2018/0035800 A1
(43) Pub. Date: Feb. 8, 2018

(54) Portable And Expandable laptop or food table

(71) Applicant: Joseph I. Okeke, MELBOUNE, FL (US)

(72) Inventor: Joseph I. Okeke, MELBOUNE, FL (US)

(21) Appl. No.: 15/227,914

(22) Filed: Aug. 3, 2016

(51) Int. Cl. A47B 3/10; A47B 3/083; A47B 9/20; A47B 13/16; A47B 37/00; H04B 1/08; A47B 19/10; A47B 21/02; A47B 21/03; A47B 23/06; H02S 10/40; H04M 1/04; A47B 1/04; A47B 19/08

(52) U.S. Cl. CPC A47B 3/10; A47B 1/04; A47B 3/083; A47B 9/20; A47B 13/16; A47B 37/00; A47B 19/08; A47B 19/10; A47B 21/02; A47B 21/0314; A47B 23/06; H02S 10/40; H04M 1/04; H04B 1/088

(57) ABSTRACT

This special folding table is designed to be very portable since it has a size or 12 inches by 12 inches. Students that live in tight rooms at schools will love to use it or fold it up. It is a multi tasking table that can hold your laptop, drinks, food. while you read and write all at same time plus holds two or more cell phones with two bluetooth light speakers. The table is light weight for portability and could be deployed anywhere need it most. one minute you standing with a laptop bag and the next minute you have a fully functioning table appear from nowhere and making you the envy of everybody in the room. I know this because it got me my new girlfriend and we still in love.

This is My application For patent For My Portable And Expandable Tranducer Tripod Table For Laptop Use Or Food Tray Use Or Entertainment Use.

First and foremost am not asking for a restriction on commercial companies from investing on My table but instead this is an open invitation to all commercial companies all over the world willing to invest in my product idea and compensate me with 10 percent of sales or profit to be determined case by case. When you open this table it expands from one feet to three feet or more in height and one to three feet in length and width horizontally. It uses five tripod legs for floor use and also it uses four small ½ inch by two inch PVC legs for table top use. And it uses no legs for use on the bed where I use it the most. This table has two cup holders, three tall artificial palm trees, six artificial short palm tress, two book light system, two phone holder panels with two phone pockets for cell phones that rotates 360 degrees and two small bluetooth speaker system holders. Plus four 6 inch by 6 inch air suspended mouse pad. in addition to all this the table can also hold your laptop and food tray. How do I know all this well have been showing this table to Americans in all 48 states at malls and at mcdonald restaurants everywhere since am a truck driver I travel all 48 states. And my table was invented inside my truck while I travel. This is one of the best multitasking table about to be created by me for the world to enjoy.

If no commercial company wants to produce it that is ok I will build a company from scratch and I can produce it by myself. So far I am producing it inside my truck on my sleeper bed with no room in my tractor truck. So I think am doing great by myself.

This table was produced and displayed for the world on Sep. 9, 2015 so it has been about ten months and half since I made this public and published it on my facebook. I have two evidence of my product publication on Sep. 9, 2015, I called the tripod company 7 days in advance before my Sep. 14, 2015 presentation to the world. And I told them about my new invention and I spoke to Barbara Wong and she requested for product pictures so I requested for seven days for great pictures and I told her I will take this product outside for the first time to see the light of day. But when I took this product outside to take pictures for the tripod company, curious people gathered together and they said they love my table and most of them said they will attempt to steal the patent. They are nice about it and really nice people but they are also serious of stealing a patent for this table. Well I don't know yet if this table qualifies for a patent or not but i will like to put a stop finally to all the fake claim applications you currently have for my invention because a patent belongs to the inventor and since am the only one driving my truck across America thinking of my table and building it inside my truck. I deserve 100 percent full credit for my idea. Have also invested lots of money and time on research on this table. On Sep. 14, 2015, I sent out about forty images of my table to the tripod company in New Jersey USA. ToCAD America is a big tripod company in New Jersey and they reviewed my table and their reply evidence is included in this patent application so you can investigate. So I decided to create a second evidence so on Sep. 14, 2015 lots of images of my table invention was published on my facebook at “JOEYOKEKE”. Also I published it on my two YouTube accounts one is “JoeBigLotto” on youtube and the other is “Joeyokeke” also on youtube. My official facebook “Joeyokeke” has over 2000 images.

So feel free to visit my facebook to investigate, it is set to public and this evidence will be there for ten years so anyone can investigate my claims. The HomeDepot employee that sold me the parts I needed at HomeDepot store in Texarkana Tex. her name is Faith Primm she is now on my friend list on facebook and she was curious so she is among the first people to see this table on facebook so feel free to contact her.

Before I began building the first table on Sep. 1, 2015 the thinking process started I think early August of 2015 after I posted a video of another product design on youtube at late July of 2015 this product I called ZTEzmax tv because it uses Ztezmax bluetooth speakers and my cell phone and a net bag to create a new entertainment box. But this entertainment box needed a table so I created the Tranducer tripod table, evidence of this other invention was also published on my youtube channel with the famous song “never gonna give you up”.

The first person I spoke to about my new invention imagination was a co worker by the name “GARY” we both work for Continental Expedited Services Trucking company we deliver auto parts in many states in the USA. So I met him in ohio at a customer delivery so I told him I use to work with PVC in florida with bill irrigation sprinkler systems so am use to PVC. And Seven days before my display on Sep. 14, 2015 two border agents in south Texas stopped me at immigration check point in south east texas, they said what am I doing with all this tripod legs that look like guns so I showed them my new invention of a portable office table and they said great that maybe they buy one someday since they work outside in tents.

Go to Google and Google Tranducer tripod tables with five legs and you will find my videos I posted there. Also go to YouTube and type joeyokeke you see my videos I published and also go to my second youtube by typing Joebiglotto on youtube website Also visit my facebook Joeyokeke you will see pictures I published on my facebook about my table invention starting on Sep. 14, 2015.

I have shown my table to truck drivers in Wisconsin Truck stops and they like it and they all say they like the patent more so they will attempt to get it. Sometimes I am scared for my life from people telling me they will steal the patent for my invention they tell me their plans face to face because they think my invention is worth billions. Well Patent wasn't my reason for invention and to be honest I wasn't sure what a patent was so thanks to them I spent last eight months doing research on patent on Google and YouTube and I read I have up to one year to file my papers so am doing it now myself hiring a lawyer is out of the question for now. This micro patent may cost me $500 do it yourself. I don't know yet but it is my only choice. So I want USPTO to put an end to this patent war and threat to my life by making a decision and investigation on all my claims and terminating all false claims of invention currently in progress because they all know it is my table creation. The reason I know all this is that I showed my table on youtube, facebook, and at malls across America especially laredo mall in laredo Texas. So now I suspect you already have as many as 200 false applications and am sad that people love a patent of my table more than they love my table. This invention was after all was my invention for the world to enjoy. I want all countries in the world to have access and be able to use my table as long as I get my ten percent they can commercialize it. However I don't want any commercial company that wants to throw me under the bus to be allowed to market my invention. How ever my invention is free for Private Home use. I can't control what people do in the privacy of their homes but for commercialization I want my fair ten percent. I don't have a lawyer yet and I don't have offers yet either so for now am waiting for USPTO decision so I can proceed. I love my table and I love using it. And I think it will sell well because nothing like this in office depot or walmart so I built it. So when I finally do get a lawyer am willing to negotiate fair deals with companies making offers. Am not greedy. My other option is to sell my invention to the highest bidder. I will love to sell my invention for $10 million dollars plus extra ten percent of sales if sales exceed $100 millon dollars.

This Tranducer table is the greatest invention of my life a portable fun table you can have in your bag with you when you need it. I have not sold any or tried to because I want to sell only a factory finished product so I need USPTO approval to proceed. I estimate as many as 200 people including my friends, relatives and even co workers in Laredo Tex. under management of MR Carlos who was among the first people to see my table at my Job office. I strongly believe Mr Carlos is secretly working behind me to claim a patent for this table based on body language alone. I was also at a truckstop in Rockwall Tex. and the security guard by the name Mr Priddle came to me and I thought he wanted to kick me out for using my table at their facility this was October 2015 one month after my invention. He said no I like your table and I want a slice of the Patent and that he thinks my table is worth one billion dollars. Am like have met over 200 people that love my table so am letting USPTO to know this. They all saw me in public so I want a full investigation in my case. And I also want USPTO to show my pictures to all patent applicants of my table and if they honest they wilt all confirm am the one in public with this table they can all look me up on my facebook. I thought about this table myself, I built a proto type myself and I published it on my facebook on Sep. 14, 2015 which was the first publication anywhere in the world. I sent pictures to tripod company between Sep. 12 and Sep. 14, 2015.

So far I have spent over $2000 in research and development on this table. This I think is my gift and contribution to the world or inventions and inventors. If I make money great if I don't great too. But I love my table and I love using it and have spent the last eight months improving on it every single day. Am currently a truck driver and my table was invented inside my truck as I travel across America. So my travel experience helps in my invention mood. So I know lots of people from texas to kentucky to wisconsin to Tennessee to New Mexico may be trying to apply for my invention idea but I just want you to know all applications you have so far now is false because this is my first application ever for a patent with USPTO.

Sometimes am worried to show it. I showed it at the mall in Laredo Tex. and the other day the chinese guy there saw me and he said you are the table guy so I feel like a little celebrity. But I won't be surprise if my design is not already in china. But not all news are bad since I began showing my table in the mall. I met my new girlfriend in the mall, she saw me with my table and she said she wants both of us meaning me and my table. So am very happy with our love progress. So she made me loss focus on filing this application on time earlier but now am back on track. Included with this patent is my seven month improvement I made, four air suspended round or square 6 inch cork mat for mouse pad or eating napkins. it works and looks great.

What makes this table so special is that it fits in my laptop bag with my laptop, People are always surprised how a big table comes out from a little portable bag with my laptop too. They shake my hands and then tell me we are going to try to get the patent. Am like seriously everybody wants my table patent now so please USPTO investigate my case with all your available crime unit I want them all to be stopped because they will interfere with my ability to move forward with my invention.

As I stated above this table product was also sent to the tripod company on Sep. 14, 2015. It was sent to ToCAD AMERICA INC in New Jersey U.S.A about forty images and pictures. It was received by Barbara Wong at Bwong @ tocad.com and it was reviewed by John Long SR product manager at ToCAD AMERICA INC and this was what his replied email said. He said “Dear Joseph, I want to thank you for your submission of the images and idea of your prototype for an adjustable laptop desk, I have discussed your idea with our Management here at ToCAD, while it is very ingenious and seems like an extremely interesting idea, and we greatly appreciate the thought and the care that has gone into making this sample, unfortunately this unit is not in the product category that we market or sell, therefore we must regretfully pass on the opportunity to go forward with your plans. We might suggest that you contact invent Help or another place like that”.

### DESCRIPTIONS

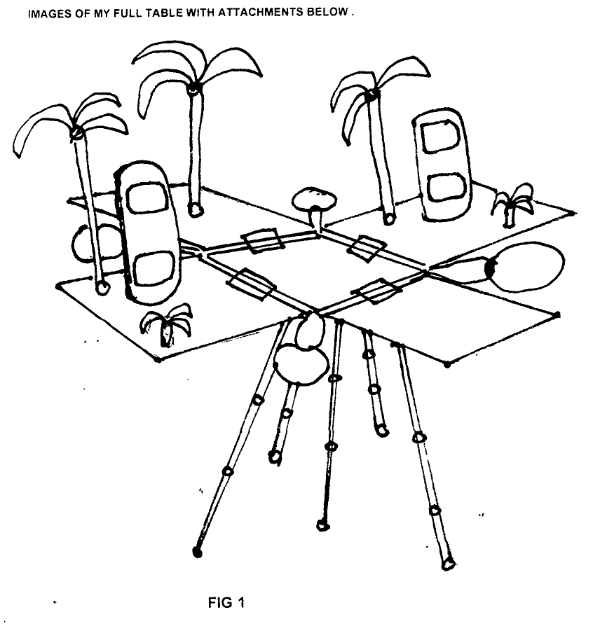

FIG. 1 shows the beautiful table when opened from the carry bag and deployed legs are attached via pvc connectors and tightened with a washer and screw and wind nut. The clipboards that opens up in all four direction has two insert rods each that pulls out from under the table this has a tee plate and a screw with wind nut to tighten or release the insert rods. All the attachments on the table all have a screw washer and wind nut that locks attachment on top of table. All the attachments like palm trees and phone pockets and cup holders goes in a separate bag from the table this way your artificial palm trees stays very fresh.

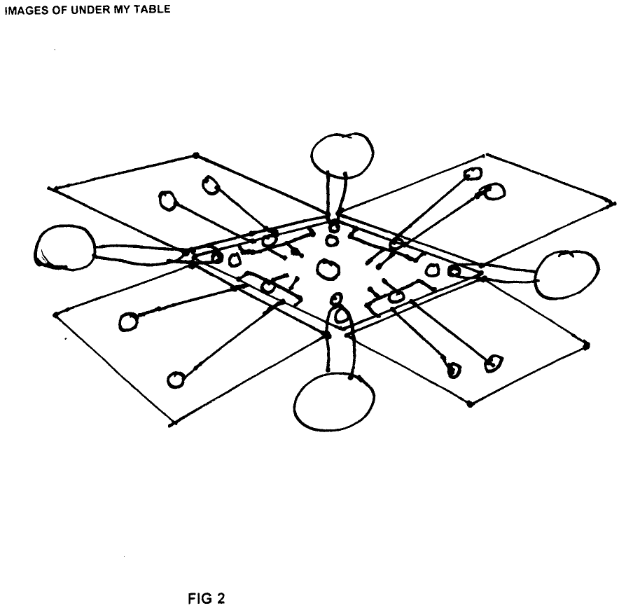

FIG. 2 shows the table upside down the insert rod helping to hold the table open with wind nuts to lock it or open it under table. This table has a 12 inch by 12 inch drywall aluminum plate this is light and strong and four clip boards are attached to this. The aluminum plate is the center strength of my table design. The four mouse pads all folds back in beneath the table for storage.

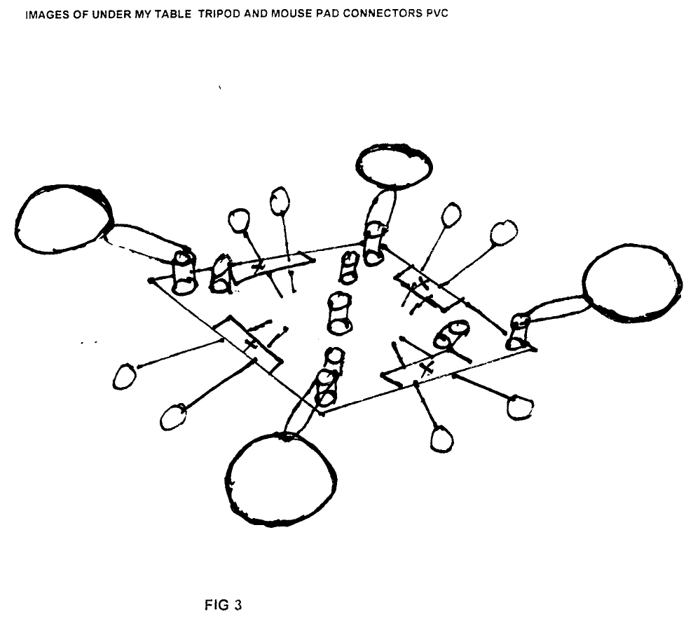

FIG. 3 shows the PVC connectors for the five tripod legs or four table top legs. The PVC leg connector at the center of this table goes up straight at 90 degrees. While the PVC leg connectors at the corners of this table goes out at about 45 degrees on all four sides this increase stability while the center leg at 90 degrees absorb weight.

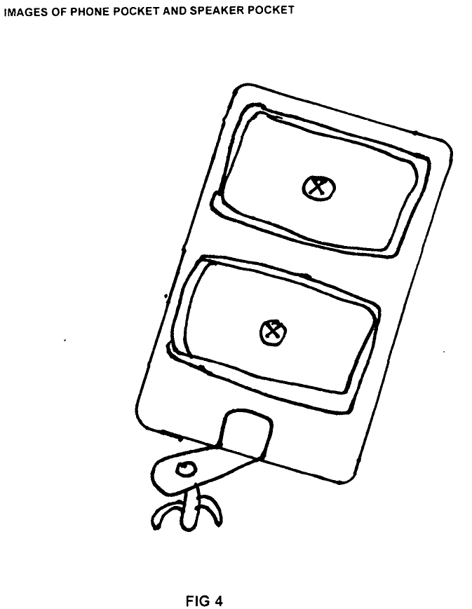

FIG. 4 shows phone and speaker plate with phone pocket and speaker pocket.

This attaches to the table top with screw, washer and wind nut. The phone pocket and speaker pocket are rubber materials so it can expand a little to hold phone and speaker tight the phone pocket rotates 360 degrees because it has one screw and one wind nut. The speaker pocket has three screws and three wind nut so not design to rotate like phone so it is below the phone.

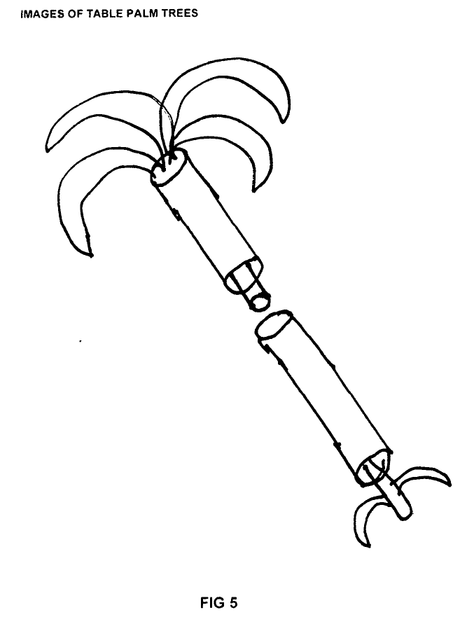

FIG. 5 shows the Big palm trees. This are ½ inch PVC and this tree has two section so it can break into two parts to fit in your bag the small palm trees are small so no need to break them. The bottom of this PVC has a screw and wind nut to attach the palm tree to top of table and lock under with wind nut. The body is covered with texture fabric to look like real white palms. And The palm leaves are artificial plants. Very pretty so you feel like you in a tropical beach.

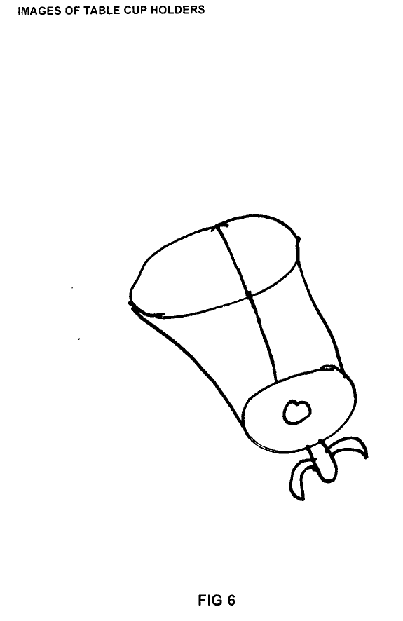

FIG. 6 shows a cup holder with screw and wind nut.

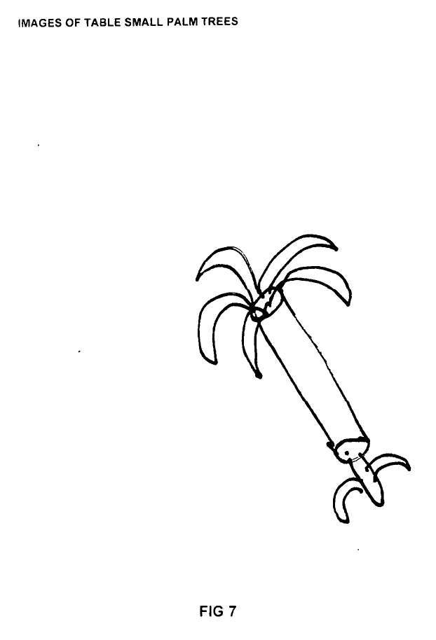

FIG. 7 shows small palm tree with screw and wind nut.

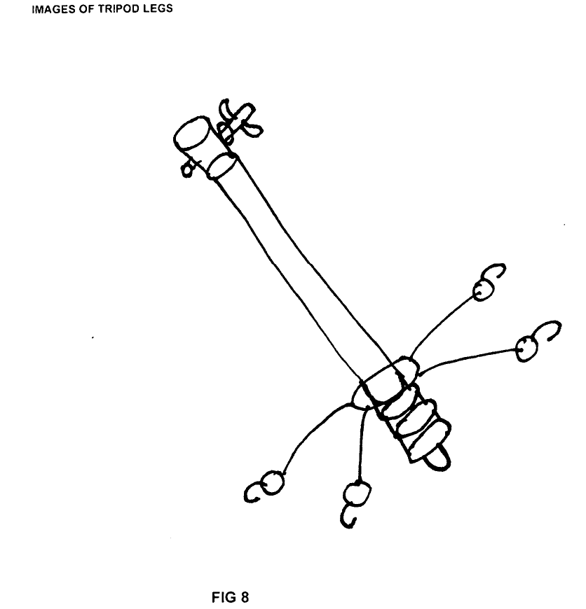

FIG. 8 shows a camera tripod leg with a PVC connector and a screw and washer and wind nut so this goes into PVC connectors under table and locks with screw and washer and wind nut. It also shows four ropes hanging loss with clips. this rope hooks up to the other four legs going out at 45 degrees so it doesn't slid away in slippery wood floor from my experience.

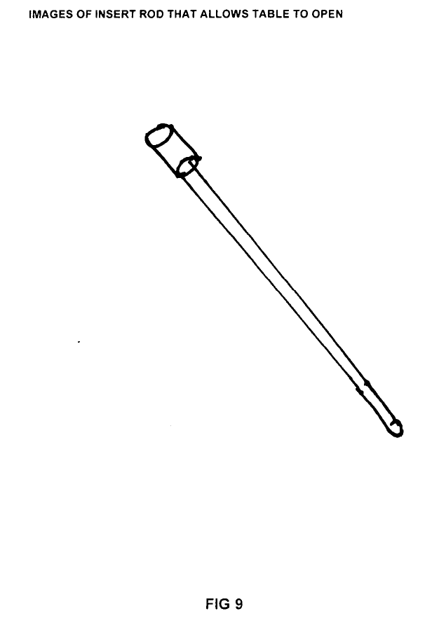

FIG. 9 shows the insert rod about 12 inches long with a small 112 inch PVC coupling. This pulls out from under table for use and pushes back in under table for storage. This table has eight inserts two per side but people can use three for heavy load.

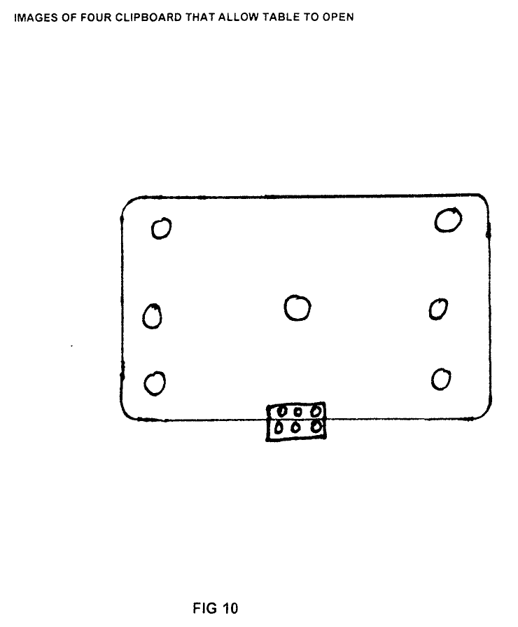

FIG. 10 shows one of four clip boards that helps this table expand. Some have pre drill holes for attachments and some do not depending on what a customer wants. It also show a door hinges so table can fold or unfold. Metallic clip board can be used here or plexiglass and can be laminated with cardboard or wall paper.

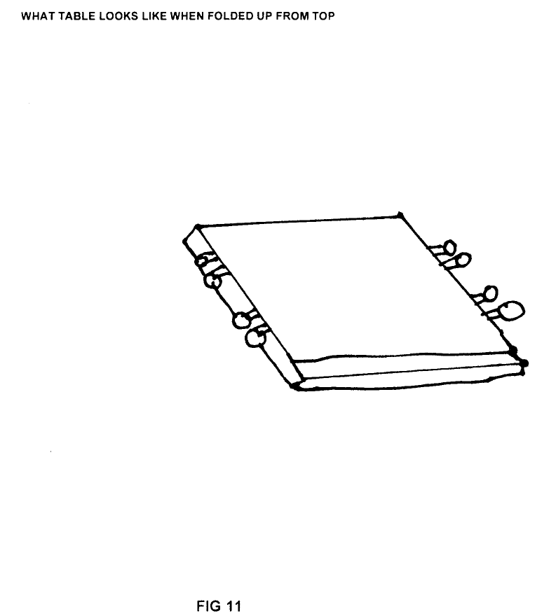

FIG. 11 shows table folded up top view ready for bag the five legs are hidden under table and the mouse pad folded in to hold them in place.

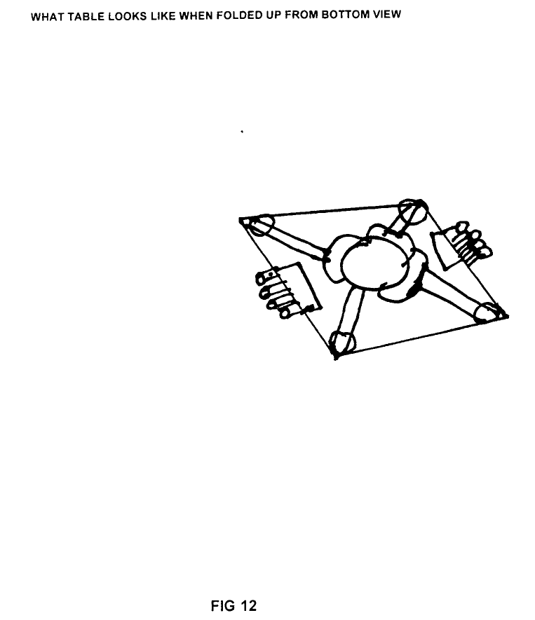

FIG. 12 show folded up bottom view with inserts and mouse pad all folded in.

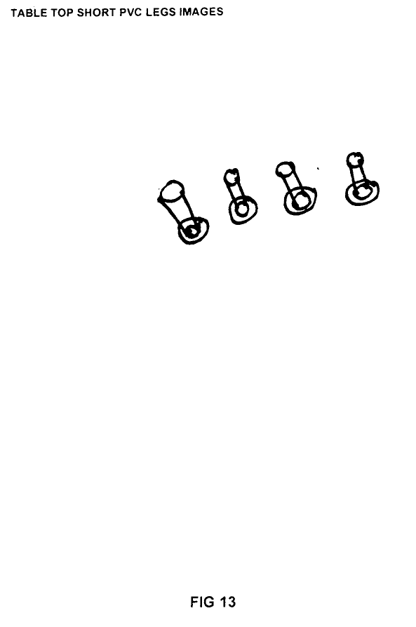

FIG. 13 shows the four small ½ inch by two inch PVC legs for those that already have a regular table so this becomes a Table top Table.

1. This table can be used for eating.

2. This table can be used used for laptops.

3. This table can be used to hold cell phones while watching youtube.

4. This table can be used as a portable solar panel to power personal electronics in future.

5. This table can be used for advanced video games with multiple panels.

6. This table can be used on uneven floors because each leg is dependently adjustable.

7. This table gives you freedom to sit and read a book anywhere if you can find a seat you have a table. And if no seat the table height can be raised so you can stand and use it.

8. This table can be used by architects to build small scale houses or projects.

9. This table can be used as a satellite receiver in the future since it opens up.

10. This table can be used by mobility people like me on the go so I have my own office to go. Thank you all very much.
